(19) United States
(12) Patent Application Publication
(10) Pub. No.: US 2026/0037100 A1
(43) Pub. Date: Feb. 5, 2026

(54) VIRTUAL IMAGE SHARING METHOD AND VIRTUAL IMAGE SHARING SYSTEM

(71) Applicant: KYOCERA Corporation, Kyoto-shi, Kyoto (JP)

(72) Inventors: Shingo ITO, Kyoto-shi, Kyoto (JP); Tomokazu ADACHI, Yokohama-shi, Kanagawa (JP)

(21) Appl. No.: 19/106,925

(22) PCT Filed: Aug. 30, 2022
(86) PCT No.: PCT/JP2022/032477

§ 371 Date: Feb. 26, 2025

(51) Int. Cl. G06F 3/04815; G06T 17/00

(52) U.S. Cl. CPC G06F 3/04815; G06T 17/00

(57) ABSTRACT

A virtual image sharing system 100 displays a first virtual image 30 that is located in a space and that is operable by a first user U1 of a wearable terminal device (first display device) 20 and a second user U2 of another wearable terminal device (second display device) 20 on each of the wearable terminal device 20 and the other wearable terminal device 20. The virtual image sharing system 100 displays, on the wearable terminal device 20, a second virtual image 40 that is located in the space, that is operable by the first user U1, and that is not displayed on the other wearable terminal device 20.

### TECHNICAL FIELD

The present disclosure relates to a virtual image sharing method and a virtual image sharing system.

### BACKGROUND OF INVENTION

VR (virtual reality), MR (mixed reality), and AR (augmented reality) are conventionally known as techniques for enabling a user to experience a virtual image and/or a virtual space using a wearable terminal device worn on the user's head. The wearable terminal device includes a display that covers the user's field of view when worn by the user. By displaying the virtual image and/or the virtual space on the display in accordance with a position and an orientation of the user, a visual effect as if the virtual image and/or the virtual space exists is produced (e.g., U.S. Patent Application Publication No. 2019/0087021 and U.S. Patent Application Publication No. 2019/0340822).

MR is a technique in which a user views a virtual image displayed in real space at a predetermined position while viewing the real space to experience mixed reality where the real space and the virtual image are combined together. Patent Literature 1, for example, discloses a technique for allowing a plurality of users wearing see-through head-mounted displays to share a virtual object (e.g., a virtual object of a building) displayed on the see-through head-mounted displays.

### CITATION LIST

### Patent Literature

Patent Literature 1: U.S. Patent Application Publication No. 2013/0293468

### SUMMARY

### Problem to be Solved

With the technique disclosed in Patent Literature 1, however, when an operation (e.g., a rotation operation or an enlargement/reduction operation) is performed on a virtual object, the virtual object looks different to each user, which poses a problem that, if the operation is performed excessively, the virtual object becomes hard to recognize. With the technique, a case can be assumed where some users might desire to operate a virtual object without being seen by other users.

A virtual image sharing method and a virtual image sharing system in the present disclosure have been conceived in view of the above problem, and aim to improve usability of a virtual image shared by a plurality of users.

### Solution to Problem

In order to solve the above problem, a virtual image sharing method in the present disclosure is a virtual image sharing method for sharing a virtual image between a plurality of display devices, which includes at least a first display device and a second display device, the virtual image sharing method including displaying, on each of the first display device and the second display device, a first virtual image that is located in a space and that is operable by a first user of the first display device and a second user of the second display device and displaying, on the first display device, a second virtual image that is located in the space, that is operable by the first user, and that is not displayed on the second display device.

In order to solve the above problem, another virtual image sharing method in the present disclosure is a virtual image sharing method for sharing a virtual image between a plurality of display devices, the virtual image sharing method including displaying, on each of the plurality of display devices, a virtual image that is located in a space and that is operable by each of users of the plurality of display devices, a first mode in which when the user of one of the plurality of display devices has performed an operation for changing a display mode of the virtual image, the virtual image displayed on the display device reflects the display mode of the virtual image changed on a basis of the operation and the virtual image displayed on another of the plurality of display devices reflects the display mode of the virtual image changed on the basis of the operation, and a second mode in which when the user of one of the plurality of display devices has performed an operation for changing the display mode of the virtual image, the virtual image displayed on the display device reflects the display mode of the virtual image changed on a basis of the operation but the virtual image displayed on another of the plurality of display devices does not reflect the display mode of the virtual image changed on the basis of the operation.

In order to solve the above problem, a virtual image sharing system in the present disclosure is a virtual image sharing system for sharing a virtual image between a plurality of display devices, which includes at least a first display device and a second display device, the virtual image sharing system performing a process including displaying, on each of the first display device and the second display device, a first virtual image that is located in a space and that is operable by a first user of the first display device and a second user of the second display device and displaying, on the first display device, a second virtual image that is located in the space, that is operable by the first user, and that is not displayed on the second display device.

In order to solve the above problem, another virtual image sharing system in the present disclosure is a virtual image sharing system for sharing a virtual image between a plurality of display devices, the virtual image sharing system performing a process including displaying, on each of the plurality of display devices, a virtual image that is located in a space and that is operable by each of users of the plurality of display devices, a first mode in which when the user of one of the plurality of display devices has performed an operation for changing a display mode of the virtual image, the virtual image displayed on the display device reflects the display mode of the virtual image changed on a basis of the operation and the virtual image displayed on another of the plurality of display devices reflects the display mode of the virtual image changed on the basis of the operation, and a second mode in which when the user of one of the plurality of display devices has performed an operation for changing the display mode of the virtual image, the virtual image displayed on the display device reflects the display mode of the virtual image changed on a basis of the operation but the virtual image displayed on another of the plurality of display devices does not reflect the display mode of the virtual image changed on the basis of the operation.

### Advantageous Effect

According to the present disclosure, usability of a virtual image shared by a plurality of users can be improved.

### BRIEF DESCRIPTION OF THE DRAWINGS

FIG. 1 is a diagram illustrating a schematic configuration of a virtual image sharing system.

FIG. 2 is a block diagram illustrating functional configuration of an information processing device.

FIG. 3 is a schematic perspective view illustrating external configuration of a wearable terminal device.

FIG. 4 is a block diagram illustrating functional configuration of the wearable terminal device.

FIG. 5 is a flowchart illustrating a control procedure of a virtual image display control process.

FIG. 6 is a flowchart illustrating a control procedure of a first reflection display process.

FIG. 7 is a flowchart illustrating a control procedure of a second reflection display process.

FIG. 8 is a diagram illustrating an example of a visible area of a first user wearing a wearable terminal device and a first virtual image viewed by the first user.

FIG. 9 is a diagram illustrating an example of the visible area of the first user wearing the wearable terminal device and the first virtual image and a second virtual image viewed by the first user.

FIG. 10 is a diagram illustrating an example of a change to a display mode of the first virtual image.

FIG. 11 is a diagram illustrating another example of the change to the display mode of the first virtual image.

FIG. 12 is a diagram illustrating another example of the visible area of the first user wearing the wearable terminal device and the first virtual image and the second virtual image viewed by the first user.

FIG. 13 is a diagram illustrating another example of the visible area of the first user wearing the wearable terminal device and the first virtual image and the second virtual image viewed by the first user.

FIG. 14 is a diagram illustrating an example of a change to a display mode of the second virtual image.

FIG. 15 is a diagram illustrating another example of the change to the display mode of the second virtual image.

FIG. 16 is a diagram illustrating another example of the visible area of the first user wearing the wearable terminal device and the first virtual image and the second virtual image viewed by the first user.

FIG. 17 is a diagram illustrating another example of the visible area of the first user wearing the wearable terminal device and the first virtual image and the second virtual image viewed by the first user.

### DESCRIPTION OF EMBODIMENTS

An embodiment will be described hereinafter on the basis of the drawings. Each drawing referred to hereinafter, however, illustrates, in a simplified manner, only key members necessary to describe the embodiment for convenience of description.

### Configuration of Virtual Image Sharing System 100

First, a virtual image sharing system 100 will be described with reference to FIG. 1. FIG. 1 is a diagram illustrating a schematic configuration of the virtual image sharing system 100.

As illustrated in FIG. 1, the virtual image sharing system 100 includes an information processing device 10 and a plurality of (e.g., two) wearable terminal devices (display devices) 20 communicably connected to the information processing device 10.

The information processing device 10 is a server device that performs display control and the like on a virtual image displayed on each wearable terminal device 20.

The wearable terminal devices 20 are HMDs (head mount displays) mounted on users' heads. More specifically, the wearable terminal devices 20 are so-called MR/AR goggles that provide MR or AR for the users.

### Configuration of Information Processing Device 10

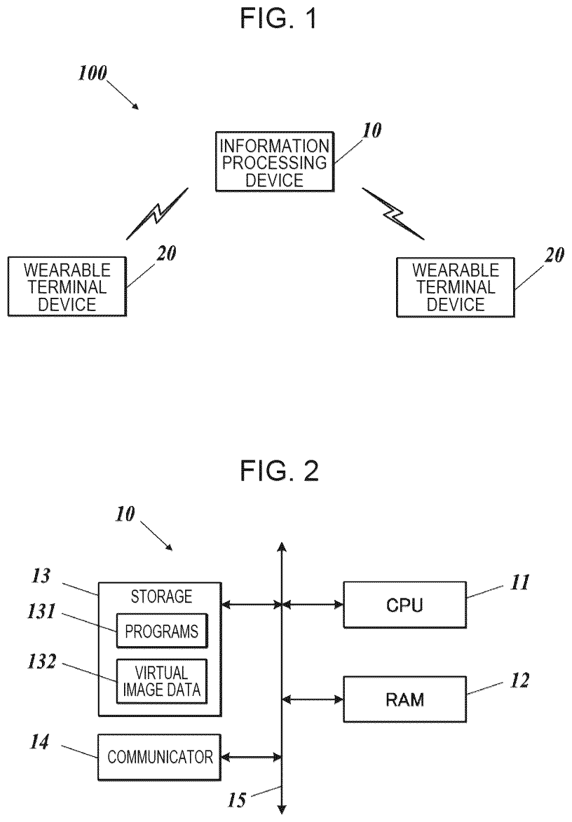

Configuration of the information processing device 10 will be described with reference to FIG. 2. FIG. 2 is a block diagram illustrating functional configuration of the information processing device 10.

As illustrated in FIG. 2, the information processing device 10 includes a CPU (central processing unit) 11, a RAM (random access memory) 12, a storage 13, a communicator 14, and a bus 15. The components of the information processing device 10 are connected to one another through the bus 15.

The CPU 11 is a processor that controls operation of each component of the information processing device 10. The CPU 11 performs various control operations by reading and executing programs 131 stored in the storage 13. Note that although FIG. 2 illustrates a single CPU 11, the number of processors is not limited to this. Two or more processors such as CPUs may be provided, instead, and the two or more processors may divide processing performed by the CPU 11 in the present embodiment and execute the divided processing.

The RAM 12 provides a working memory space for the CPU 11 and stores temporary data.

The storage 13 is a non-transitory storage medium readable by the CPU 11. The storage 13 stores the programs 131 to be executed by the CPU 11, various types of setting data, and the like. The programs 131 are stored in the storage 13 in a form of computer-readable program codes. As the storage 13, for example, a nonvolatile storage device, such as an SSD (solid state drive) including a flash memory or an HDD (hard disk drive), is used.

The data stored in the storage 13 includes virtual image data regarding a virtual image. The virtual image data includes data regarding display content of the virtual image, data regarding a display position, data regarding an orientation, and the like.

The communicator 14 communicates data with each wearable terminal device 20. For example, the communicator 14 receives data including a subset or all of results of detection performed by the sensors 25 of each wearable terminal device 20, information regarding user operations detected by each wearable terminal device 20, and the like. The communicator 14 may be capable of communicating with devices other than the wearable terminal devices 20.

### Configuration of Wearable Terminal Device 20

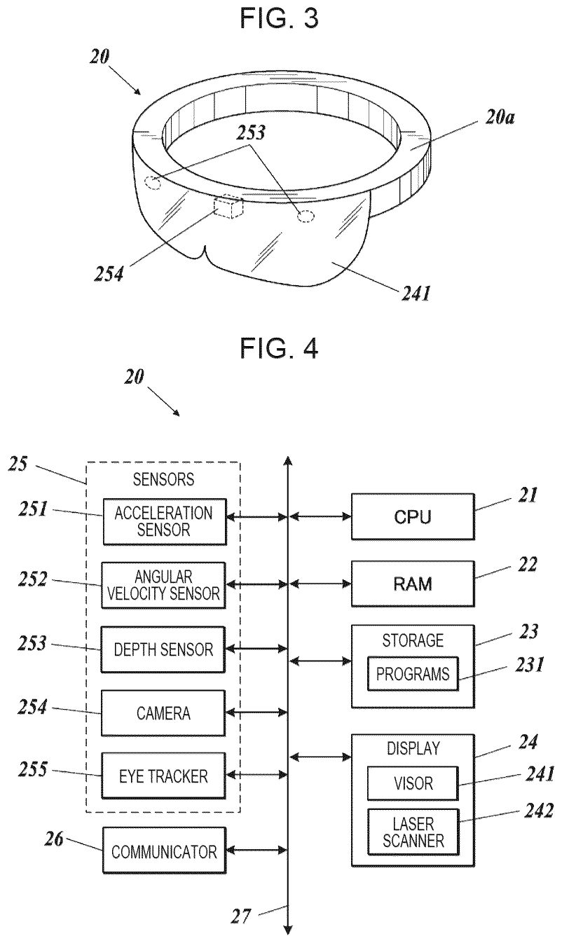

External configuration of each wearable terminal device 20 will be described with reference to FIG. 3. FIG. 3 is a schematic perspective view illustrating the external configuration of each wearable terminal device 20.

As illustrated in FIG. 3, the wearable terminal device 20 includes a main body 20a, a visor 241 (display member) attached to the main body 20a, and the like.

The main body 20a is an annular member whose circumference is adjustable. Various devices such as a depth sensor 253 and a camera 254 are built into the main body 20a. When the main body 20a is mounted on the head, the visor 241 covers the user's field of view.

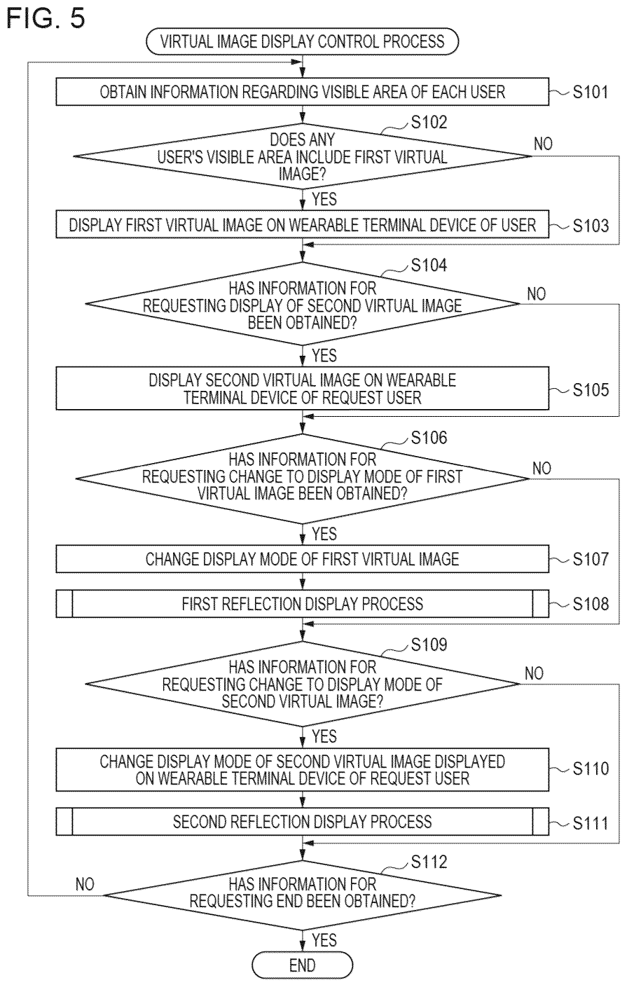

The visor 241 has light transmittance. The user can view real space through the visor 241. A laser scanner 242 (see FIG. 4) built into the main body 20a projects an image, such as a virtual image, onto a display surface of the visor 241, which faces the user's eyes, to display the image. The user views the virtual image as light reflected from the display surface. Because the user also views the real space through the visor 241 at this time, the user can experience a visual effect as if the virtual image exists in the real space.

Functional configuration of each wearable terminal device 20 will be described with reference to FIG. 4. FIG. 4 is a block diagram illustrating the functional configuration of the wearable terminal device 20.

As illustrated in FIG. 4, the wearable terminal device 20 includes a CPU 21, a RAM 22, a storage 23, a display 24, sensors 25, a communicator 26, and the like, and these component are connected to one another by a bus 27. The components of the display 24 illustrated in FIG. 4 other than the visor 241 are built into the main body 20a, and operate on power supplied from a battery, which is also built into the main body 20a.

The CPU 21 is a processor that performs various types of arithmetic processing and that controls operation of each component of the wearable terminal device 20. The CPU 21 performs various control operations by reading and executing programs 231 stored in the storage 23. The CPU 21 performs a process for detecting a visible area, for example, by executing the programs 231. The process for detecting a visible area is a process for detecting the user's visible area in space.

Note that although FIG. 4 illustrates a single CPU 21, the number of processors is not limited to this. Two or more processors such as CPUs may be provided, instead, and the two or more processors may divide processing performed by the CPU 21 in the present embodiment and execute the divided processing.

The RAM 22 provides a working memory space for the CPU 21 and stores temporary data.

The storage 23 is a non-transitory storage medium readable by the CPU 21 as a computer. The storage 23 stores the programs 231 to be executed by the CPU 21, various types of setting data, and the like. The programs 231 are stored in the storage 23 in a form of computer-readable program codes. As the storage 23, for example, a nonvolatile storage device, such as an SSD including a flash memory, is used.

The display 24 includes the visor 241, the laser scanner 242, and an optical system that guides light output from the laser scanner 242 to the display surface of the visor 241. The laser scanner 242 radiates, in accordance with a control signal from the CPU 21, pulsed laser light whose on/off is controlled for each of pixels onto the optical system while scanning the laser light in a predetermined direction. The laser light incident on the optical system forms a display screen that is a two-dimensional pixel matrix on the display surface of the visor 241. A method employed by the laser scanner 242 is not particularly limited, but a method in which laser light is scanned by moving a mirror using MEMS (micro electro mechanical systems), for example, can be employed. The laser scanner 242 includes three light emitters that emit, for example, RGB laser light. The display 24 can achieve color display by projecting the light from these light emitters onto the visor 241.

The sensors 25 include an acceleration sensor 251, an angular velocity sensor 252, a depth sensor 253, a camera 254, an eye tracker 255, and the like. Note that the sensors 25 may also include sensors not illustrated in FIG. 4.

The acceleration sensor 251 detects acceleration and outputs a result of the detection to the CPU 21. Translational motion of the first wearable terminal device 20 in three orthogonal axis directions can be detected from the result of the detection obtained by the acceleration sensor 251.

The angular velocity sensor 252 (gyroscope sensor) detects angular velocity and outputs a result of the detection to the CPU 21. Rotational motion of the first wearable terminal device 20 can be detected from the result of the detection obtained by the angular velocity sensor 252.

The depth sensor 253 is an infrared camera that detects a distance to a subject using a ToF (time of flight) method, and outputs a result of the detection of the distance to the CPU 21. The depth sensor 253 is provided on a front surface of the main body 20a so as to be able to capture an image of a visible area of the user. Three-dimensional mapping of the entirety of a space can be performed (i.e., a three-dimensional structure can be obtained) by repeatedly performing measurement using the depth sensor 253 and combining results each time a position and an orientation of the user has changed in the space.

The camera 254 captures an image of a space using RGB imaging elements, obtains color image data as a result of the capture, and outputs the color image data to the CPU 21. The camera 254 is provided on the front surface of the main body 20a so as to be able to capture an image of the visible area of the user. An output image of the camera 254 is used to detect a position and an orientation of the first wearable terminal device 20 and the like, and is transmitted to an external device from the communicator 26 and used to display the visible area of the user of the first wearable terminal device 20 on the external device.

The eye tracker 255 detects the user's line of sight and outputs a result of the detection to the CPU 21. A method for detecting a line of sight is not particularly limited, but, for example, a method can be used in which an eye tracking camera captures an image of a point on the user's eye at which near-infrared light is reflected and a target viewed by the user is identified by analyzing a result of the capture and the image captured by the camera 254. A subset of components of the eye tracker 255 may be provided in a peripheral part of the visor 241 or the like.

The communicator 26 is a communication module including an antenna, a modulation/demodulation circuit, a signal processing circuit, and the like. The communicator 26 wirelessly communicates data with external devices in accordance with a predetermined communication protocol.

In the wearable terminal device 20 having such a configuration, the CPU 21 performs the following control operation.

The CPU 21 performs three-dimensional mapping of a space on the basis of distance data regarding a distance to a subject input from the depth sensor 253. The CPU 21 updates a result by repeatedly performing the three-dimensional mapping each time the position and the orientation of the user change. The CPU 21 performs the three-dimensional mapping in units of connected spaces. When the user moves between a plurality of rooms separated by walls or the like, therefore, the CPU 21 recognizes each room as a space and individually performs the three-dimensional mapping for each room.

The CPU 21 detects the user's visible area in a space. More specifically, the CPU 21 identifies the position and the orientation of the user (wearable terminal device 20) in a space on the basis of results of detection performed by the acceleration sensor 251, the angular velocity sensor 252, the depth sensor 253, the camera 254, and the eye tracker 255 and accumulated results of the three-dimensional mapping. The visible area is detected (identified) on the basis of the identified position and orientation and a predetermined shape of the visible area. The CPU 21 continues to detect the position and the orientation of the user in real-time and updates the visible area in accordance with changes in the position and the orientation of the user. Note that the visible area may be detected using a subset of the results of the detection performed by the acceleration sensor 251, the angular velocity sensor 252, the depth sensor 253, the camera 254, and the eye tracker 255, instead.

### Operation of Virtual Image Sharing System 100

A control procedure of a virtual image display control process performed as part of operation of the virtual image sharing system 100 will be described with reference to FIG. 5. The CPU 11 of the information processing device 10 performs the virtual image display control process.

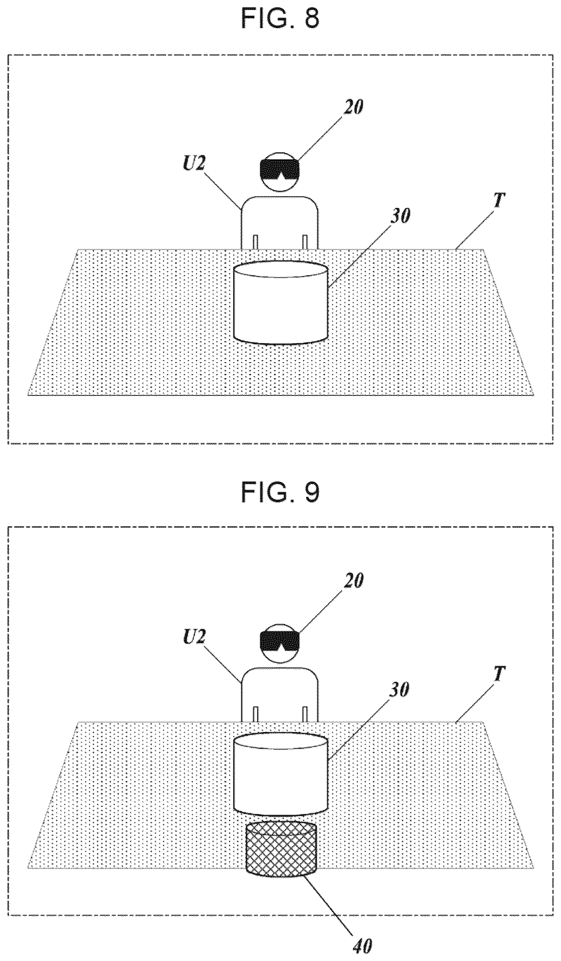

Here, before the virtual image display control process is performed, a first virtual image 30 (e.g., a cylindrical first virtual image 30; see FIG. 8) is generated in advance with a display position and an orientation determined in a certain real space (e.g., a meeting room). The first virtual image 30 is an image operable by the user wearing each wearable terminal device 20.

FIG. 5 is a flowchart illustrating the control procedure of the virtual image display control process.

As illustrated in FIG. 5, when the virtual image display control process is started, first, the CPU 11 of the information processing device 10 obtains information regarding the visible area of each user wearing the wearable terminal device 20 from the wearable terminal device 20 through the communicator 14 (step S101). Here, the user wearing one of the two wearable terminal devices 20 (first display device) included in the virtual image sharing system 100 is defined as a first user U1, and the user wearing the other wearable terminal device (second display device) 20 is defined as a second user U2.

The CPU 11 determines whether any user's visible area includes the first virtual image 30 on the basis of the information regarding the visible area of each user obtained in step S101 (step S102).

If determining in step S102 that any user's visible area includes the first virtual image 30 (step S102: YES), the CPU 11 displays the first virtual image 30 on the wearable terminal device 20 (visor 241) of the user (step S103).

FIG. 8 is a diagram illustrating an example of the visible area of the first user U1 wearing the wearable terminal device 20 and the first virtual image 30 viewed by the first user U1.

As illustrated in FIG. 8, when the first virtual image 30 is displayed, the first user U1 views the first virtual image 30 oriented in a predetermined direction at a predetermined position on a table T in the space (e.g., the meeting room). The first user U1 also views the second user U2 wearing the wearable terminal device 20 on another side (opposite side) of the table T. This space is a real space viewed by the first user U1 through the visor 241. Since the first virtual image 30 is projected onto the visor 241 having light transmittance, the first virtual image 30 is recognized as a translucent image overlapping the real space. In FIG. 8, the visible area of the first user U1 is indicated by a dash-dot line.

Referring back to the description of the control procedure of the virtual image display control process in FIG. 5, if determining in step S102 that no user's visible area includes the first virtual image 30 (step S102; NO), the CPU 11 causes the process to proceed to step S104 while skipping step S103.

The CPU 11 determines whether information for requesting display of a second virtual image 40 has been obtained from any wearable terminal device 20 through the communicator 14 (step S104). Here, the second virtual image 40 is a virtual image obtained by copying (includes a reduced copy or an enlarged copy) the first virtual image 30 displayed in the space. The second virtual image 40 is displayed only on the wearable terminal device 20 (visor 241) worn by a user who has performed the operation for requesting display of the second virtual image 40. That is, the second virtual image 40 displayed on the wearable terminal device 20 can be operated by only the user wearing the wearable terminal device 20. A method for operating the second virtual image 40 may be, for example, a so-called gesture operation performed by detecting movement of the user's hands using the wearable terminal device 20, an operation by a controller (not illustrated) provided for the wearable terminal device, or the like (the same and/or similar statement holds for a method for operating the first virtual image 30).

If determining in step S104 that information for requesting display of the second virtual image 40 has been obtained from any wearable terminal device 20 (step S104: YES), the CPU 11 causes the wearable terminal device 20 (visor 241) worn by the user (request user) who has requested display of the second virtual image 40 to display the second virtual image 40 (step S105). If the user who has requested display of the second virtual image 40 is the first user U1, for example, the second virtual image 40 is displayed on the wearable terminal device 20 (visor 241) worn by the first user U1, and the second virtual image 40 is not displayed on the wearable terminal device 20 (visor 241) worn by the second user U2. If the second user U2 has requested display of the second virtual image 40, on the other hand, the second virtual image 40 is displayed on the wearable terminal device 20 (visor 241) worn by the second user U2, and the second virtual image 40 is not displayed on the wearable terminal device 20 (visor 241) worn by the first user U1. That is, when each of the first user U1 and the second user U2 requests display of the second virtual image 40, a dedicated second virtual image 40 is displayed on the wearable terminal device 20 (visor 241) worn by the user. With the virtual image sharing system 100 according to the present embodiment, each wearable terminal device 20 can thus display the second virtual image 40 that is a copy of the first virtual image 30, and each user wearing the wearable terminal device 20 can simulate an operation for the first virtual image 30 using the second virtual image 40 displayed on the wearable terminal device 20 worn thereby. As a result, an operation is not excessively performed on the first virtual image 30, and a problem that the first virtual image 30 becomes hard to recognized can be eliminated. Since each user can freely simulate an operation for the first virtual image 30 without being seen or interrupted by other users, usability of the first virtual image 30 shared by the users can be improved.

FIG. 9 is a diagram illustrating an example of the visible area of the first user U1 wearing the wearable terminal device 20 and the first virtual image 30 and the second virtual image 40 viewed by the first user U1.

As illustrated in FIG. 9, when the first user U1 requests display of the second virtual image 40, the first user U1 views the first virtual image 30 displayed on the table T and also views the second virtual image 40 oriented in the same direction as the first virtual image 30 at a predetermined position in front of the first virtual image 30. Since the second virtual image 40 is projected onto the visor 241 having light transmittance as with the first virtual image 30, the second virtual image 40 is recognized as a translucent image overlapping the real space. Although the second virtual image 40 is displayed as an image obtained by reducing size of the first virtual image 30 by a predetermined factor in the example illustrated in FIG. 9, an image whose magnification is the same as that of the first virtual image 30 or an image obtained by enlarging the first virtual image 30 by a predetermined factor may be displayed, instead.

Referring back to the description of the control procedure of the virtual image display control process in FIG. 5, if determining in step S104 that information for requesting display of the second virtual image 40 has not been obtained from any wearable terminal device 20 (step S104; NO), the CPU 11 causes the process to proceed to step S106 while skipping step S105.

The CPU 11 determines whether information for requesting a change to a display mode of the first virtual image 30 has been obtained from any wearable terminal device 20 through the communicator 14 (step S106).

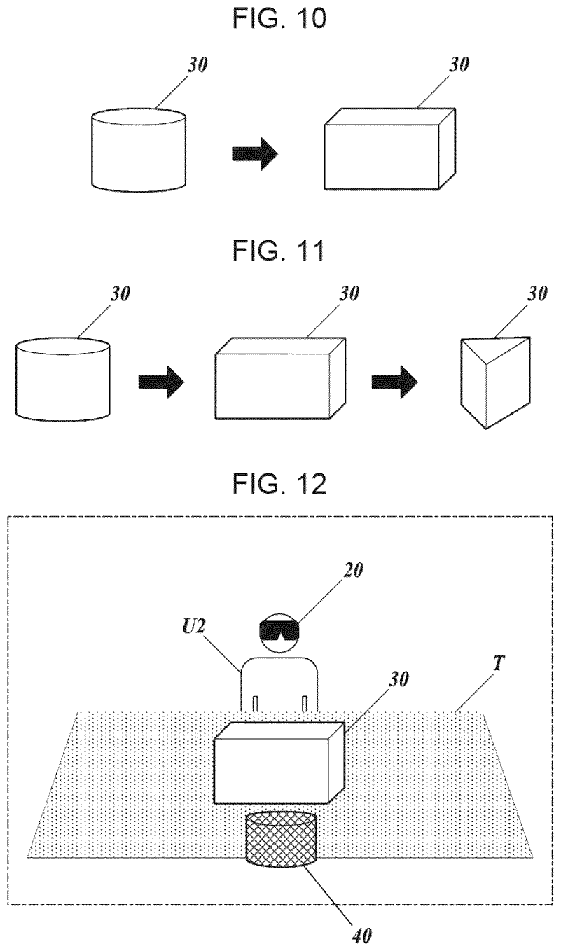

If determining in step S106 that information for requesting a change to the display mode of the first virtual image 30 has been obtained from any wearable terminal device 20 (step S106: YES), the CPU 11 changes the display mode of the first virtual image 30 on the basis of the information (step S107). More specifically, if the information for requesting a change to the display mode of the first virtual image 30 obtained from the wearable terminal device 20 is information for requesting a change of a shape of the first virtual image 30 to a rectangular parallelepiped shape, the CPU 11 changes the shape of the first virtual image 30 to a rectangular parallelepiped shape as illustrated in FIG. 10. If the information obtained from the wearable terminal device 20 is information for requesting a change of the shape of the first virtual image 30 to a rectangular parallelepiped shape and then to a triangular prism shape, for example, the CPU 11 changes the shape of the first virtual image 30 to the rectangular parallelepiped shape and then to the triangular prism shape as illustrated in FIG. 11.

FIG. 12 is a diagram illustrating another example of the visible area of the first user U1 wearing the wearable terminal device 20 and the first virtual image 30 and the second virtual image 40 viewed by the first user U1.

When the shape of the first virtual image 30 has been changed to a rectangular parallelepiped shape in accordance with the operation performed by the second user U2 as illustrated in FIG. 12, for example, the first user U1 views the first virtual image 30 whose shape has been changed to the rectangular parallelepiped shape and also views the second virtual image 40 (cylindrical second virtual image 40) at the predetermined position in front of the first virtual image 30. Note that although not illustrated, at this time, the second user U2 wearing the wearable terminal device 20, too, views the first virtual image 30 whose shape has been changed to the rectangular parallelepiped shape.

Referring back to the description of the control procedure of the virtual image display control process in FIG. 5, after performing the processing in step S107, the CPU 11 performs a first reflection display process (step S108).

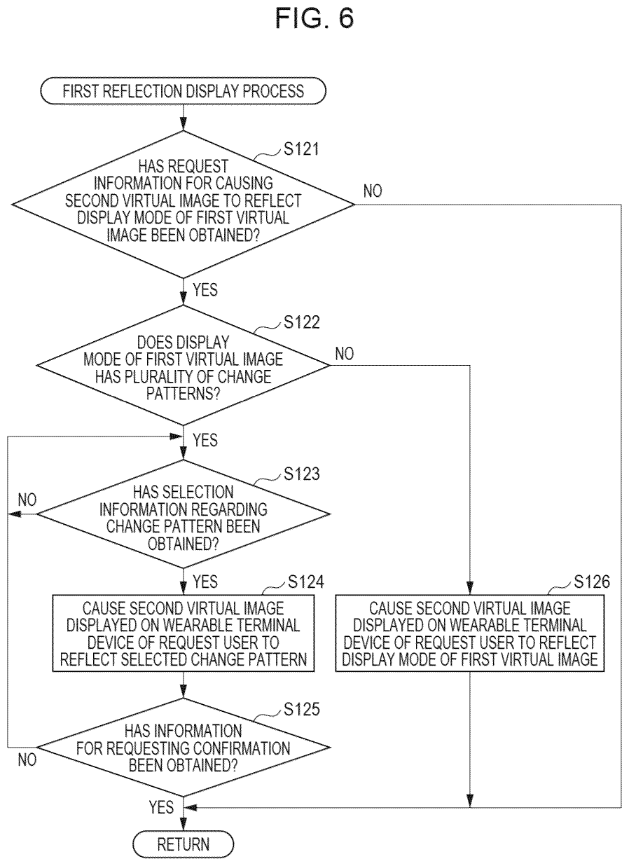

FIG. 6 is a flowchart illustrating a control procedure of the first reflection display process.

As illustrated in FIG. 6, when the first reflection display process is started, first, the CPU 11 of the information processing device 10 determines whether request information for causing the second virtual image 40 to reflect the display mode of the first virtual image 30 has been obtained from any wearable terminal device 20 through the communicator 14 (step S121).

If determining in step S121 that request information for causing the second virtual image 40 to reflect the display mode of the first virtual image 30 has not been obtained from any wearable terminal device 20 (step S121; NO), the CPU 11 causes the process to return to the virtual image display control process (see FIG. 5), and performs the processing in step S109 and later steps.

If determining in step S121 that request information for causing the second virtual image 40 to reflect the display mode of the first virtual image 30 has been obtained from any wearable terminal device 20 (step S121: YES), the CPU 11 determines whether the display mode of the first virtual image 30 changed in step S107 of the virtual image display control process (see FIG. 5) has a plurality of change patterns (step S122).

If determining in step S122 that the display mode of the first virtual image 30 has a plurality of change patterns (step S122: YES), the CPU 11 determines whether selection information regarding a change pattern has been obtained from the wearable terminal device 20 worn by a request user (a user who has requested the second virtual image 40 to reflect the display mode of the first virtual image 30) through the communicator 14 (step S123). Note that when a desired one of the plurality of change patterns is to be selected and the change patterns include a change pattern in which a first additional image (not illustrated) is added to the first virtual image 30 in a certain display mode and a change pattern in which a second additional image (not illustrated) is added to the first virtual image 30 in the certain display mode, a change pattern in which both the first additional image and the second additional image are added to the first virtual image 30 in the certain display mode may also be added.

If determining in step S123 that selection information regarding a change pattern has not been obtained (step S123: NO), the CPU 11 repeatedly performs the determination processing in step S123 until obtaining the selection information.

If determining in step S123 that selection information regarding a change pattern has been obtained (step S123: YES), the CPU 11 causes, on the basis of the obtained selection information, the second virtual image 40 displayed on the wearable terminal device 20 worn by the request user to reflect the selected change pattern (step S124). When, as described above, the shape of the first virtual image 30 is changed to a rectangular parallelepiped shape (first change pattern) and then to a triangular prism shape (second change pattern) (see FIG. 11) and selection information for selecting the rectangular parallelepiped shape (first change pattern) has been obtained from the wearable terminal device 20 worn by the request user as the selection information regarding a change pattern, for example, the CPU 11 causes the second virtual image 40 displayed on the wearable terminal device 20 of the request user to reflect the rectangular parallelepiped shape, which is the selected change pattern (first change pattern).

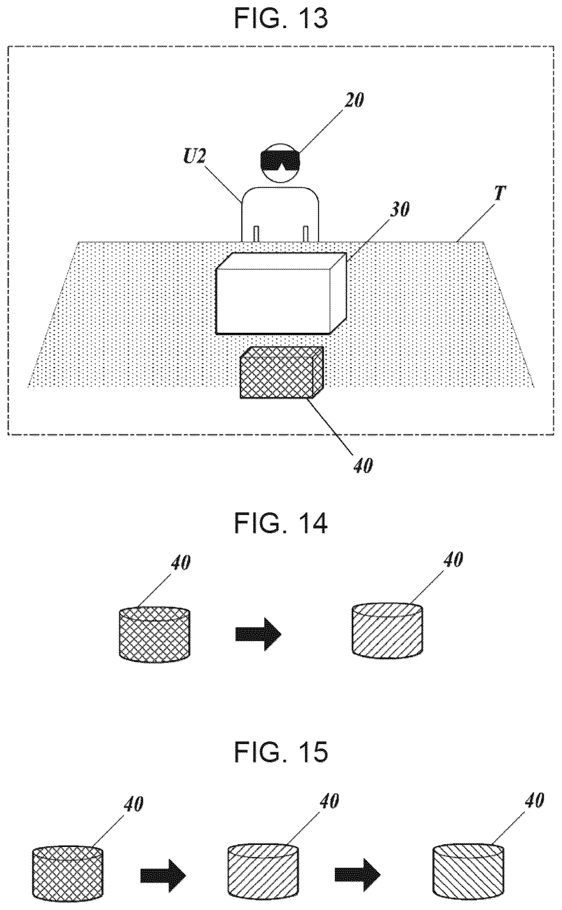

FIG. 13 is a diagram illustrating another example of the visible area of the first user U1 wearing the wearable terminal device 20 and the first virtual image 30 and the second virtual image 40 viewed by the first user U1.

As illustrated in FIG. 13, when the second virtual image 40 has reflected the display mode (rectangular parallelepiped shape) of the first virtual image 30 in accordance with the operation performed by the first user U1, the first user U1 views the first virtual image 30 of the rectangular parallelepiped shape and also views the second virtual image 40 that has reflected the rectangular parallelepiped shape at the predetermined position in front of the first virtual image 30.

Referring back to the control procedure of the first reflection display process in FIG. 6, after performing the processing in step S124, the CPU 11 determines whether information for requesting confirmation of the reflection display from the wearable terminal device 20 worn by the request user (step S125).

If determining in step S125 that information for requesting confirmation of the reflection display has been obtained (step S125: YES), the CPU 11 causes the process to return to the virtual image display control process (see FIG. 5), and performs the processing in step S109 and later steps.

If determining in step S125 that information for requesting confirmation of the reflection display has not been obtained (step S125: NO), the CPU 11 causes the process to return to step S123, and repeatedly performs subsequent processing.

If determining in step S122 that the display mode of the first virtual image 30 does not have a plurality of change patterns (step S122: NO), the CPU 11 causes the second virtual image 40 displayed on the wearable terminal device 20 of the request user (the user who has requested the second virtual image 40 to reflect the display mode of the first virtual image 30) to reflect a new display mode of the first virtual image 30 (step S126). When the shape of the first virtual image 30 has been changed to a rectangular parallelepiped shape as described above (see FIG. 10), for example, the CPU 11 causes the second virtual image 40 displayed on the wearable terminal device 20 of the request user to reflect the rectangular parallelepiped shape after the change (see FIG. 13). The CPU 11 causes the process to return to the virtual image display control process (see FIG. 5), and performs the processing in step S109 and later steps.

Referring back to the description of the control procedure of the virtual image display control process in FIG. 5, the CPU 11 determines whether information for requesting a change to a display mode of the second virtual image 40 has been obtained from any wearable terminal device 20 through the communicator 14 (step S109).

If determining in step S109 that information for requesting a change to the display mode of the second virtual image 40 has been obtained from any wearable terminal device 20 (step S109: YES), the CPU 11 changes the display mode of the second virtual image 40 displayed on the wearable terminal device 20 on the basis of the information (step S110). More specifically, if the information for requesting a change to the display mode of the second virtual image 40 obtained from the wearable terminal device 20 is information for requesting a change of a display color of the second virtual image 40 to red, for example, the CPU 11 changes the display color of the second virtual image 40 to red (ascending hatching represents red in the figure) on the basis of the information as illustrated in FIG. 14. If the information obtained from the wearable terminal device 20 is information for requesting a change of the display color of the second virtual image 40 to red and then to yellow, for example, the CPU 11 changes the display color of the second virtual image 40 to red and then to yellow (descending hatching represents yellow in the figure) on the basis of the information as illustrated in FIG. 15.

FIG. 16 is a diagram illustrating another example of the visible area of the first user U1 wearing the wearable terminal device 20 and the first virtual image 30 and the second virtual image 40 viewed by the first user U1.

As illustrated in FIG. 16, when the display color of the second virtual image 40 has been changed to red in accordance with the operation performed by the first user U1, the first user U1 views the first virtual image 30 (cylindrical first virtual image 30) displayed on the table T and also views the second virtual image 40 whose display color has been changed to red.

Referring back to the description of the control procedure of the virtual image display control process in FIG. 5, after performing the processing in step S110, the CPU 11 performs a second reflection display process (step S111).

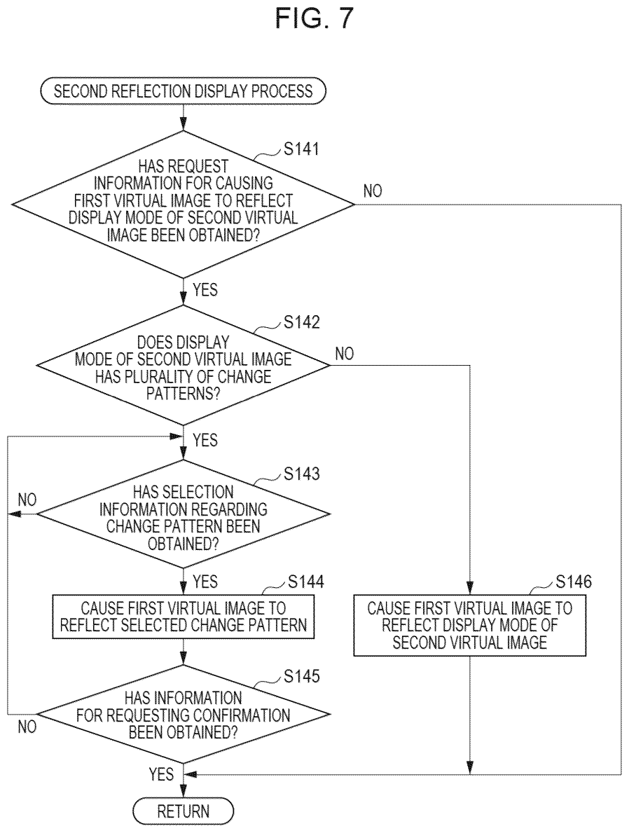

FIG. 7 is a flowchart illustrating a control procedure of the second reflection display process.

As illustrated in FIG. 7, when the second reflection display process is started, first, the CPU 11 of the information processing device 10 determines whether request information for causing the first virtual image 30 to reflect the display mode of the second virtual image 40 has been obtained from any wearable terminal device 20 through the communicator 14 (step S141).

If determining in step S141 that request information for causing the first virtual image 30 to reflect the display mode of the second virtual image 40 has not been obtained from any wearable terminal device 20 (step S141; NO), the CPU 11 causes the process to return to the virtual image display control process (see FIG. 5), and performs the processing in step S112 and later steps.

If determining in step S141 that request information for causing the first virtual image 30 to reflect the display mode of the second virtual image 40 has been obtained from any wearable terminal device 20 (step S141: YES), the CPU 11 determines whether the display mode of the second virtual image 40 changed in step S110 of the virtual image display control process (see FIG. 5) has a plurality of change patterns (step S142).

If determining in step S142 that the display mode of the second virtual image 40 has a plurality of change patterns (step S142: YES), the CPU 11 determines whether selection information regarding a change pattern has been obtained from the wearable terminal device 20 worn by a request user (a user who has requested the first virtual image 30 to reflect the display mode of the second virtual image 40) through the communicator 14 (step S143). Note that when a desired one of the plurality of change patterns is to be selected and the change patterns include a change pattern in which a third additional image (not illustrated) is added to the second virtual image 40 in a certain display mode and a change pattern in which a fourth additional image (not illustrated) is added to the second virtual image 40 in the certain display mode, a change pattern in which both the third additional image and the fourth additional image are added to the second virtual image 40 in the certain display mode may also be added.

If determining in step S143 that selection information regarding a change pattern has not been obtained (step S143: NO), the CPU 11 repeatedly performs the determination processing in step S143 until obtaining the selection information.

If determining in step S143 that selection information regarding a change pattern has been obtained (step S143: YES), the CPU 11 causes the first virtual image 30 displayed on each wearable terminal device 20 to reflect the selected change pattern on the basis of the obtained selection information (step S144). When the display color of the second virtual image 40 has been changed to red (first change pattern) and then to yellow (second change pattern) as described above (see FIG. 15) and selection information for selecting red (first change pattern) has been obtained from the wearable terminal device 20 worn by the request user as the selection information regarding a change pattern, for example, the CPU 11 causes the first virtual image 30 displayed on each wearable terminal device 20 to reflect red, which is the selected change pattern (first change pattern).

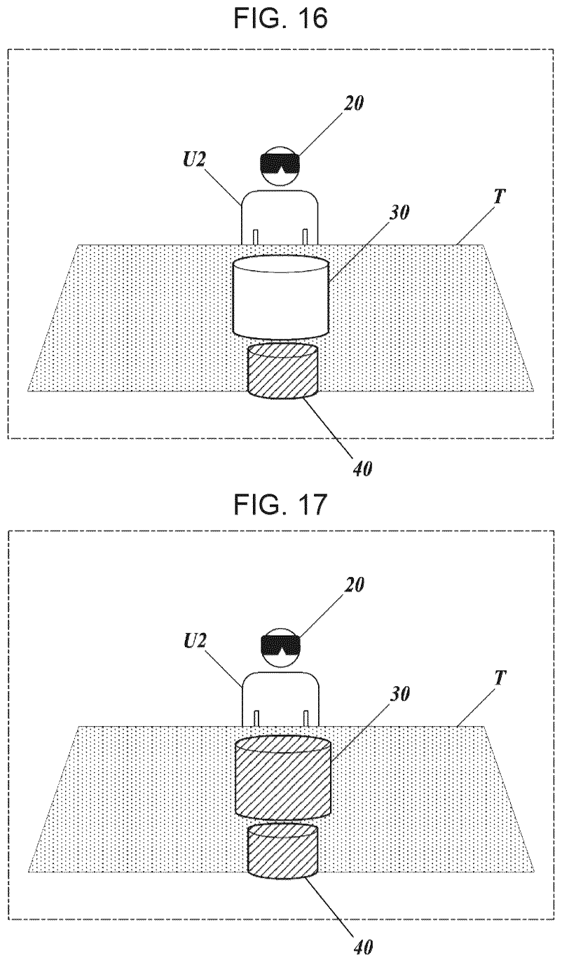

FIG. 17 is a diagram illustrating another example of the visible area of the first user U1 wearing the wearable terminal device 20 and the first virtual image 30 and the second virtual image 40 viewed by the first user U1.

As illustrated in FIG. 17, when the first virtual image 40 has reflected the display color (red) of the second virtual image 40 changed in accordance with the operation performed by the first user U1, the first user U1 views the second virtual image 40 that has turned red and also views the first virtual image 30 that has reflected red.

Referring back to the description of the control procedure of the second reflection display process in FIG. 7, after performing the processing in step S144, the CPU 11 determines whether information for requesting confirmation of the reflection display has been obtained from the wearable terminal device 20 worn by the request user (step S145).

If determining in step S145 that information for requesting confirmation of the reflection display (step S145: YES), the CPU 11 causes the process to return to the virtual image display control process (see FIG. 5), and performs the processing in step S112 and later steps.

If determining in step S145 that information for requesting confirmation of the reflection display has not been obtained (step S145; NO), the CPU 11 causes the process to return to step S143, and repeatedly performs subsequent processing.

If determining in step S142 that the display mode of the second virtual image 40 does not have a plurality of change patterns (step S142: NO), the CPU 11 causes the first virtual image 30 displayed on each wearable terminal device 20 to reflect a new display mode of the second virtual image 40 (step S146). When the display color of the second virtual image 40 has been changed to red as described above (see FIG. 14), for example, the CPU 11 causes the first virtual image 30 displayed on each wearable terminal device 20 to reflect red, which is a new display color (see FIG. 17). The CPU 11 causes the process to return to the virtual image display control process (see FIG. 5), and performs the processing in step S112 and later steps.

Referring back to the description of the control procedure of the virtual image display control process in FIG. 5, the CPU 11 determines whether information for requesting ending of the virtual image display control process has been obtained from any wearable terminal device 20 through the communicator 14 (step S112).

If determining in step S112 that information for requesting ending of the virtual image display control process has not been obtained from any wearable terminal device 20 (step S112: NO), the CPU 11 causes the process to return to step S101, and repeatedly performs subsequent processing.

If determining in step S112 that information for requesting ending of the virtual image display control process has been obtained from any wearable terminal device 20 (step S112; YES), the CPU 11 ends the virtual image display control process.

### Additional Information

Note that the above embodiment is an example, and various changes may be made.

Although a case where the first virtual image 30 displayed as if the first virtual image 30 exists in real space is shared by users has been described for the virtual image sharing system 100 according to the above embodiment, for example, the first virtual image 30 may be displayed in a virtual space and shared by avatars displayed differently in accordance with movement of the users, instead. In this case, the wearable terminal devices are of a VR type. In this case, while each user is performing an operation on the second virtual image 40, the displayed avatar does not reflect movement corresponding to the operation. In doing so, each user can operate the second virtual image 40 without the knowledge of the other users. In this case, while one of the users is operating the second virtual image 40, an operation on the first virtual image 30 is inhibited. In doing so, each user can refer to the first virtual image 30 while performing an operation on the second virtual image 40, which enables the user to smoothly perform the operation.

Although the display mode of the first virtual image 30 is changed on the basis of information for requesting a change to the display mode of the first virtual image 30 obtained from a wearable terminal device 20 in step S107 of the virtual image display control process (see FIG. 5) in the above embodiment, users who are enabled to make such a change and users who are inhibited from making such a change may be set in the information processing device 10.

Although when information for requesting display of the second virtual image 40 has been obtained from any wearable terminal device 20, the second virtual image 40 is displayed on the wearable terminal device 20 worn by a user who has requested display of the second virtual image 40 in the above embodiment, the second virtual image 40 may be displayed on the wearable terminal device 20 only if, for example, the first virtual image 30 is displayed on the wearable terminal device 20. Even if the first virtual image 30 is not displayed on the wearable terminal device 20, the second virtual image 40 may be displayed on the wearable terminal device 20 insofar as the wearable terminal device 20 is located near a display position of the first virtual image 30.

Although the second reflection display process is performed in step S111 of the virtual image display control process (see FIG. 5) and the first virtual image 30 is caused to reflect the display mode of the second virtual image 40 on the basis of request information for causing the first virtual image 30 to reflect the display mode of the second virtual image 40 in the above embodiment, users who are enabled to cause the first virtual image 30 to reflect the display mode of the second virtual image 40 and users who are inhibited from causing the first virtual image 30 to reflect the display mode of the second virtual image 40 may be set in the information processing device 10.

The display modes of the first virtual image 30 and the second virtual image 40 described in the above embodiment are merely examples.

Although the usability of the first virtual image 30 is improved by using both the first virtual image 30 and the second virtual image 40 in the above embodiment, a first mode in which when the first user U1 wearing a wearable terminal device 20 has performed an operation for changing the display mode of the first virtual image 30, not only the first virtual image 30 displayed on the wearable terminal device 20 but also the first virtual image 30 displayed on another wearable terminal device 20 reflect the display mode of the first virtual image 30 changed on the basis of the operation and a second mode in which when the first user U1 wearing a wearable terminal device 20 has performed an operation for changing the display mode of the first virtual image 30, the first virtual image 30 displayed on the wearable terminal device 20 reflects the display mode of the first virtual image 30 changed on the basis of the operation but the first virtual image 30 displayed on another wearable terminal device 20 does not reflect the display mode, for example, may be provided, and the usability of the first virtual image 30 may be improved by switching between these modes, instead.

In the second mode, as a method for causing only the first virtual image 30 displayed on the wearable terminal device 20 of the first user U1 to reflect the display mode of the first virtual image 30 changed on the basis of the operation performed by the first user U1, for example, the wearable terminal device 20 worn by the first user U1 may transmit, to the information processing device 10, information for requesting a change to the display mode of the first virtual image 30 issued by the first user U1. The information processing device 10 may generate information regarding a new display mode of the first virtual image 30 on the basis of the information and transmit the information only to the wearable terminal device 20 worn by the first user U1. As another method, for example, the information processing device 10 may transmit virtual image data 132 regarding the first virtual image 30 to the wearable terminal device 20 worn by the first user U1 in advance. Upon obtaining the virtual image data 132, the wearable terminal device 20 may change the display mode of the first virtual image 30 by performing the display control process in a standalone manner in accordance with an operation performed by the first user U1.

Specific details of the configuration and control described in the above embodiment may be altered without deviating from the spirit of the present disclosure. Different types of configuration and control described in the above embodiment may be appropriately combined together without deviating from the spirit of the present disclosure.

### INDUSTRIAL APPLICABILITY

The present disclosure can be used in a virtual image sharing method and a virtual image sharing system.

### REFERENCE SIGNS

100 virtual image sharing system
10 information processing device
11 CPU
12 RAM
13 storage
131 programs
132 virtual image data
14 communicator
15 bus
20 wearable terminal device
21 CPU
22 RAM
23 storage
231 programs
24 display
241 visor
242 laser scanner
25 sensors
251 acceleration sensor
252 angular velocity sensor
253 depth sensor
254 camera
255 eye tracker
26 communicator
27 bus

1. A virtual image sharing method for sharing a virtual image between a plurality of display devices, which includes at least a first display device and a second display device, the virtual image sharing method comprising:
displaying, on each of the first display device and the second display device, a first virtual image that is located in a space and that is operable by a first user of the first display device and a second user of the second display device; and
displaying, on the first display device, a second virtual image that is located in the space, that is operable by the first user, and that is not displayed on the second display device.

2. The virtual image sharing method according to claim 1,
wherein the second virtual image is a virtual image based on the first virtual image.

3. The virtual image sharing method according to claim 2,
wherein the second virtual image is a virtual image obtained by copying the first virtual image.

4. The virtual image sharing method according to claim 1, further comprising:
causing, when at least one of the first user and the second user has performed an operation for changing a display mode of the first virtual image, the first virtual image displayed on each of the first display device and the second display device to reflect the change.

5. The virtual image sharing method according to claim 1,
wherein the space is a virtual space,
the virtual image sharing method further comprising:
displaying, in the virtual space, a first avatar that is displayable on each of the first display device and the second display device and that is displayed differently in accordance with movement of the first user; and
causing, while the first user is performing an operation on the second virtual image, the displayed first avatar not to reflect movement corresponding to the operation.

6. The virtual image sharing method according to claim 5,
inhibiting, while the first user is performing an operation on the second virtual image, an operation on the first virtual image.

7. The virtual image sharing method according to claim 3, further comprising:
causing, when the second user has performed an operation for changing a display mode of the first virtual image, the second virtual image displayed on the first display device to reflect a new display mode of the first virtual image in accordance with a predetermined operation performed by the first user.

8. The virtual image sharing method according to claim 7, further comprising:
causing, when the second user has performed an operation for changing the display mode of the first virtual image to a first display mode and an operation for changing the display mode of the first virtual image to a second display mode, the second virtual image displayed on the first display device to selectively reflect the first display mode or the second display mode in accordance with a predetermined operation performed by the first user.

9. The virtual image sharing method according to claim 8, further comprising:
causing, when the first display mode is a display mode in which a first additional image is added to the first virtual image and the second display mode is a display mode in which a second additional image is added to the first virtual image, the second virtual image displayed on the first display device to selectively reflect the first display mode, the second display mode, or a third display mode in which the first additional image and the second additional image are added to the first virtual image in accordance with a predetermined operation performed by the first user.

10. The virtual image sharing method according to claim 3, further comprising:
causing, when the first user has performed an operation for changing a display mode of the second virtual image, the first virtual image to reflect a new display mode of the second virtual image in accordance with a predetermined operation performed by the first user.

11. The virtual image sharing method according to claim 10, further comprising:
causing, when the first user has performed an operation for changing the display mode of the second virtual image to a fourth display mode and an operation for changing the display mode of the second virtual image to a fifth display mode, the first virtual image to selectively reflect the fourth display mode or the fifth display mode in accordance with a predetermined operation performed by the first user.

12. The virtual image sharing method according to claim 11, further comprising:
causing, when the fourth display mode is a display mode in which a third additional image is added to the second virtual image and the fifth display mode is a display mode in which a fourth additional image is added to the second virtual image, the first virtual image to selectively reflect the fourth display mode, the fifth display mode, or a sixth display mode in which the third additional image and the fourth additional image are added to the second virtual image in accordance with a predetermined operation performed by the first user.

13. A virtual image sharing method for sharing a virtual image between a plurality of display devices, the virtual image sharing method comprising:
displaying, on each of the plurality of display devices, a virtual image that is located in a space and that is operable by each of users of the plurality of display devices; and
providing a first mode in which when the user of one of the plurality of display devices has performed an operation for changing a display mode of the virtual image, the virtual image displayed on the display device reflects the display mode of the virtual image changed on a basis of the operation and the virtual images displayed on the other display devices reflect the display mode of the virtual image changed on the basis of the operation and a second mode in which when the user of one of the plurality of display devices has performed an operation for changing the display mode of the virtual image, the virtual image displayed on the display device reflects the display mode of the virtual image changed on a basis of the operation but the virtual images displayed on the other display devices do not reflect the display mode of the virtual image changed on the basis of the operation.

14. A virtual image sharing system for sharing a virtual image between a plurality of display devices, which includes at least a first display device and a second display device, the virtual image sharing system performing a process comprising:
displaying, on each of the first display device and the second display device, a first virtual image that is located in a space and that is operable by a first user of the first display device and a second user of the second display device; and
displaying, on the first display device, a second virtual image that is located in the space, that is operable by the first user, and that is not displayed on the second display device.

15. (canceled)
